(19) United States
(12) Patent Application Publication
(10) Pub. No.: US 2002/0015827 A1
(43) Pub. Date: Feb. 7, 2002

(54) Ink jet recording sheet for pigment ink and recording method therefor

(75) Inventors: Hiroyuki Fujii, Kanagawa (JP); Yasumasa Yukawa, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Asahi Glass Company, Limited, Chiyoda-ku (JP)

(21) Appl. No.: 09/870,799

(22) Filed: Jun. 1, 2001

(30) Foreign Application Priority Data
Jun. 21, 2000 (JP) 2000-186395

(51) Int. Cl. B41M 5/00

(52) U.S. Cl. 428/195

(57) ABSTRACT

An ink jet recording sheet for pigment ink, which comprises a paper substrate having a surface with an Oken smoothness of from 30 to 500 seconds and a Stöckigt sizing degree of from 30 to 2,000 seconds, and an ink-receiving layer comprising a pigment and a binder, formed on the surface of the substrate, wherein the Oken smoothness of the surface of the ink-receiving layer is from 50 to 2,000 seconds.

The present invention relates to an ink jet recording sheet for pigment ink, having a high color forming property and an excellent pigment-fixing property, and a recording method therefor.

In recent years, reflecting wide use of digital cameras and computers, hard copy technology to record images thereof on e.g. paper sheets has been developed rapidly. The ultimate goal of such hard copies is a silver salt photograph, and particularly, how to bring the color reproduction property, the image density, the gloss, the weather resistance, etc. close to those of a silver salt photograph is an objective for the research and development. Hard copy recording systems include, in addition to one wherein a display of an image by a silver salt photograph is directly photographed, various types such as a dye diffusion thermal transfer system, an ink jet system and an electro photography system.

Among them, the ink jet system has merits such that the apparatus is relatively small in size and the running cost is low, and thus it is considered to be a main system for a hard copy system, together with the dye diffusion thermal transfer system. The ink jet system is a system wherein ink droplets comprising a colorant and a large amount of a solvent, are ejected from a nozzle towards a recording medium at a high speed. Printers employing such an ink jet system, have been widely used in recent years, since full color printing or high speed printing is thereby easy, and the printing noise is thereby low.

Recently, a high level of fastness is required for hard copied images depending upon the particular application, and in such an application, a printer employing a pigment type ink wherein the colorant is a pigment, has been commonly used. The pigment-type ink has a merit in that problems with a conventional dye ink i.e. problems relating to light resistance, water resistance and feathering, can thereby be solved. Further, it employs a basically the same colorant as used in plate printing such as offset printing or gravure printing, whereby the developed color hue is similar and has now been employed for color correction output so-called color proofing.

However, when an ink jet recording sheet for a conventional dye type ink, is employed as an ink jet recording sheet for a pigment ink, there has been a problem such that the developed color density is inadequate, or the fixing between the pigment and the receiving layer is inadequate, whereby the ink tends to peel when the image portion is rubbed. JP-A-11-78225 discloses a recording medium wherein the fixing property of a pigment has been improved for an ink jet printing employing such a pigment ink. However, such a recording medium is one having a pigment-fixing layer having certain specific physical properties, on an ink-receiving layer formed on a paper substrate, whereby the production becomes correspondingly cumbersome, and the cost likewise increases.

It is an object of the present invention to provide an ink jet recording sheet for a pigment ink which has a high developed color density, while maintaining merits of employing a pigment ink, such as light resistance, water resistance and little feathering, without necessity to provide a special pigment-fixing layer, and which has an adequate fixing property of the pigment ink in the ink-receiving layer, and to provide a recording method for such a recording sheet.

To accomplish the above object, the present invention provides an ink jet recording sheet for pigment ink, which comprises a paper substrate having a surface with an Oken smoothness of from 30 to 500 seconds and a Stöckigt sizing degree of from 30 to 2,000 seconds, and an ink-receiving layer comprising a pigment and a binder, formed on the surface of the substrate, wherein the Oken smoothness of the surface of the ink-receiving layer is from 50 to 2,000 seconds.

According to the present invention, as mentioned above, a high developed color density and a sufficient fixing property of the pigment ink in the ink-receiving layer can be obtained, while maintaining the merits of employing a pigment ink, such as light resistance, water resistance and little feathering, but the mechanism is not necessarily clearly understood, although it is assumed to be as follows.

Namely, according to the findings by the present inventors, as is different from the case employing a dye ink, in the case of ink jet printing employing a pigment ink, only the dispersion medium in the ink penetrates into the porous layer constituting the ink-receiving layer selectively, and the pigment particles (hereinafter referred to as pigment ink particles) in the pigment ink will remain as attached to the surface of the ink-receiving layer or in the vicinity thereof. In such a case, the properties of the obtained image will be substantially influenced by the smoothness of the surface of the recording sheet, more microscopically, by the smoothness of the surface of the ink-receiving layer. Namely, if the smoothness of the surface of the ink-receiving layer is too good, there will be no anchoring effect, and the pigment ink particles merely attach to the ink-receiving layer surface, and no adequate fixing property can be obtained, whereby they are likely to be removed by simple abrasion. Further, the obtained image tends to have a metallic gloss and is likely to undergo a so-called bronzing phenomenon. On the other hand, in a case where the smoothness of the surface of the ink-receiving layer is poor, and the surface is too roughened, the pigment ink particles tend to be embedded by the roughened surface of the ink-receiving layer, and only a part of pigment ink particles will be exposed on the surface, whereby a developed color density tends to be low.

In the recording sheet of the present invention, an ink-receiving layer is formed on the surface of a paper substrate having the above-mentioned specific smoothness and the specific Stöckigt sizing degree, whereby the formed ink-receiving layer has the above-mentioned specific smoothness. Accordingly, it is considered that in the ink jet printing, the pigment ink particles will not only stay at the surface of the ink-receiving layer, i.e. a part thereof will be embedded in the ink-receiving layer and thus will be fixed by a so-called anchor effect, and at the same time, a part of the pigment ink particles will stay at the surface of the ink-receiving layer, whereby a high developed color density will be obtained.

Now, the present invention will be described in further detail with reference to the preferred embodiments.

In the present specification, the Oken smoothness is a value measured in accordance with JAPAN TAPPI pulp and paper test method NO. 5B, and the Stöckigt sizing degree is a value measured in accordance with JIS P8122.

The paper substrate to be used in the present invention, is required to have the specific smoothness and the specific Stöckigt sizing degree, as mentioned above. Namely, one having an Oken smoothness of from 30 to 500 seconds and a Stöckigt sizing degree of from 30 to 2,000 seconds, are required. If the Stöckigt sizing degree of the surface of the ink-receiving layer is less than 30 seconds, the smoothness of the ink-receiving layer surface will be poor, and the developed color density will be low. On the other hand, if the Oken smoothness exceeds 2,000 seconds, the smoothness of the ink-receiving layer surface will be too good, whereby the fixing property of the pigment ink particles tends to be inadequate, and a bronzing phenomenon is likely to result.

Further, if the Stöckigt sizing degree is less than 30 seconds, the coating fluid to form the ink-receiving layer tends to penetrate deeply into the inside of the paper substrate, whereby the smoothness of the ink-receiving layer surface tends to be poor, and the developed color density tends to be low. On the other hand, if the Stöckigt sizing degree exceeds 2,000 seconds, the coating fluid to form an ink-receiving layer tends not to penetrate so much into the inside of the paper substrate, whereby the smoothness of the ink-receiving layer surface tends to be too high, whereby the fixing property of the pigment ink particles tends to be inadequate, and the bronzing phenomenon is likely to result.

Especially, it has been found that in the present invention, a paper substrate having an Oken smoothness of from 30 to 150 seconds and a Stöckigt sizing degree of from 30 to 1,000 seconds, is particularly preferred.

In the present invention, the material of the paper substrate is not particularly limited. However, preferably, acidic paper, neutral paper or coated paper which is commonly used in the coated paper field, can be employed. A paper substrate made of such a material may be subjected to a smoothing treatment such as calender treatment.

In the present invention, the ink-receiving layer to be formed on the paper substrate, is made of a layer comprising a pigment and a binder. Here, the pigment may, for example, be colloidal silica, alumina, alumina hydrate, synthetic fine particulate silica, synthetic fine particulate alumina silicate, fumed synthetic silica, zeolite, montmorillonite group minerals, beidellite group minerals, saponite group minerals, hectorite group minerals, stevensite group minerals, hydrotalcite group minerals, smectite group minerals, bentonite group minerals, calcium carbonate, magnesium carbonate, calcium sulfate, barium sulfate, titanium oxide, titanium sol, zinc oxide, zinc carbonate, aluminum silicate, calcium silicate, magnesium silicate, kaoline, talc, aluminum oxide, aluminum hydroxide, a polyaluminum hydroxide compound, a plastic pigment, a urea resin pigment, cellulose particles or starch particles. Among them, alumina hydrate is preferred, and particularly preferred is boehmite (Al₂O₃.nH₂O, n=1 to 1.5) in view of the excellent ink absorptivity and fixing property.

As the above binder, a water-soluble polymer, an alcohol-soluble polymer or a mixture thereof, such as gelatine, starch or its modified product, polyvinyl alcohol or its modified product, polyvinyl pyrrolidone, styrene/butadiene rubber latex, nitrile/butadiene rubber latex, methyl cellulose, carboxy methyl cellulose, hydroxy cellulose, hydroxy methyl cellulose, polyacrylic acid or polyacrylamide, may, for example, be employed. Among them, in the present invention, it is particularly preferred to employ polyvinyl alcohol or its modified product, since the ink absorptivity and water-resistance are good.

The binder is suitably used preferably in an amount of from 1 to 30 parts by mass, particularly preferably from 3 to 15 parts by mass, per 100 parts by mass of the above pigment in the ink-receiving layer.

As a means to provide an ink-receiving layer on the surface of a paper substrate, it is possible to employ, for example, a method which comprises adding a binder to a pigment to form a slurry, coating the slurry by means of e.g. a roll coater, an air knife coater, a blade coater, a rod coater, a bar coater, a comma coater, a gravure coater, a die coater, a curtain coater, a spray coater, or a slide die coater, and drying it.

The thickness of the ink-receiving layer to be thus formed, may suitably be selected depending upon the specification of the printer to be used, but it is usually preferably from 5 to 100 μm. If the thickness is less than the above range, the solvent in the ink may not sufficiently be absorbed. On the other hand, if the thickness exceeds the above range, the transparency is likely to be impaired, and the strength of the ink-receiving layer may be low. Especially, the thickness of the ink-receiving layer is preferably from 10 to 50 μm.

In the recording sheet of the present invention, the smoothness of the surface of the ink-receiving layer is required to be from 50 to 2,000 seconds as the Oken smoothness, as mentioned above. If the Oken smoothness is within this range, the developed color density of the printed image will be high, and the fixing property of the image will be excellent. If the Oken smoothness is less than 50 seconds, the developed color density decreases by light scattering caused by fine irregularities on the surface. On the other hand, if the Oken smoothness exceeds 2,000 seconds, the fixing of the pigment ink to the receiving layer tends to be inadequate, and the pigment ink tends to be easily peeled when the image surface is rubbed. The Oken smoothness is particularly preferably from 50 to 1,000 seconds. Further preferably, the Oken smoothness is from 200 to 700 seconds.

In the present invention, if a paper substrate having the above-mentioned specific Oken smoothness and the specific Stöckigt sizing degree, is not employed, even if the Oken smoothness of the ink-receiving layer surface is within a range of from 50 to 2,000 seconds, the recording sheet tends to have a poor ink absorptivity. In the present invention, a suitable smoothing treatment such as calender treatment, may be applied to the ink-receiving layer surface, as the case requires.

In the foregoing, the recording sheet of the present invention has been described, but various treatments may be applied, as the case requires, to the recording sheet of the present invention. For example, various rear side coating layers may be formed on the back side of the ink-receiving layer, to prevent curling or to improve the paper transportation property.

When ink jet recording is applied to the recording sheet of the present invention, the pigment ink to be used, is preferably one containing the pigment ink particles in an amount of from 0.5 to 20 mass % in the pigment ink. One containing the pigment ink particles in an amount of from 2 to 12 mass %, is further preferred. To the pigment ink, a dispersant, an anti-oxidation agent or a viscosity-controlling agent may, for example, be added, as the case requires.

As the pigment ink particles, various organic pigments or inorganic pigments may be employed. The organic pigments may, for example, be pigments of e.g. azo type, anthraquinone type, phthalocyanine type, quinacridone type, isoindorine type, dioxadine type, perinone type, perylene type, isodigo type, quinophthalone type or diketopyrrolopyrrole type, may, for example, be mentioned.

The inorganic pigment may, for example, be an oxide type pigment such as a titanium oxide type, cadmium oxide type, iron oxide type, chromic acid type or silicic acid type pigment, a sulfide type pigment, a carbonate salt type pigment, a metal complex type pigment or a pigment such as carbon black. Such a pigment is preferably such that the particles in the ink are particles of from a few nm to a few hundreds nm. Further, as the solvent for the ink, deionized water can be used.

Now, the present invention will be described in further detail with reference to Examples. However, it should be understood that the present invention is by no means restricted to such specific Examples.

Examples 1 to 4 are Working Examples of the present invention, and Examples 5 to 7 are Comparative Examples. Further, “parts” in the Examples means “parts by mass” unless otherwise specified.

### EXAMPLE 1

On one side surface of woodfree paper having an Oken smoothness of 100 seconds and a Stöckigt sizing degree of 210 seconds and having a weight of 157 g/m², the following ink-receiving layer formulation 1 was coated by a bar coater so that the thickness of the coating layer after drying would be 20 μm, followed by drying at 120° C. to obtain an ink jet recording sheet.

Ink-receiving Layer Formulation 1

Alumina sol (Cataloid AS-3, tradename, manufactured by Shokubai Kasei Kogyo K.K.): 100 parts, polyvinyl alcohol (PVA-124, tradename, manufactured by Kuraray Co., Ltd.): 10 parts.

### EXAMPLE 2

The ink jet recording sheet obtained in Example 1, was subjected to super calender treatment (line speed: 5 m/min, roll temperature: 20° C., nipping pressure: 50 kN/m) by a mini-super calender (manufactured by Yuri Roll Machine Co., LTD.), to carry out smoothing treatment of the surface of the ink-receiving layer.

### EXAMPLE 3

An ink jet recording sheet was prepared in the same manner as in Example 1 except that instead of the ink-receiving layer formulation 1, the following ink-receiving layer formulation 2 was employed.

Ink-receiving Layer Formulation 2

Silica sol (Snowtex UP, tradename, manufactured by Nissan Chemical Industries, Ltd.): 100 parts, polyvinyl alcohol (R-1130, tradename, manufactured by Kuraray Co., Ltd.): 10 parts.

### EXAMPLE 4

On one side surface of woodfree paper having an Oken smoothness of 35 seconds and a Stöckigt sizing degree of 35 seconds and having a weight of 157 g/m², the ink-receiving layer formulation 1 was coated in the same manner as in Example 1, followed by drying to obtain an ink jet recording sheet.

### EXAMPLE 5

An ink jet recording sheet was prepared in the same manner as in Example 1 except that instead of the ink-receiving layer formulation 1, the following ink-receiving layer formulation 3 was used.

Ink-receiving layer formulation 3

Amorphous silica (P78A, tradename, manufactured by Mizusawa Industrial Chemicals, Ltd.): 100 parts, polyvinyl alcohol (R-1130, tradename, manufactured by Kuraray Co., Ltd.): 40 parts.

### EXAMPLE 6

An ink jet recording sheet was prepared in the same manner as in Example 1 except that a paper substrate is one having a polyethylene resin coated by melt extrusion in a coating amount of 20 g/m² on each side of a paper having an Oken smoothness of at least 5,000 seconds and weight of 157 g/m², whereby paper substrate had a Stöckigt sizing degree having a value so large that it was not measurable by the machine.

### EXAMPLE 7

On one side surface of woodfree paper having an Oken smoothness of 25 seconds and a Stöckigt sizing degree of 20 seconds and having a weight of 157 g/m², the above-mentioned ink-receiving layer formulation 1 was coated by a bar coater so that the thickness of the coating layer after drying would be 20 μm, followed by drying at 120° C. to obtain an ink jet recording sheet.

The Oken smoothness of the surface of the ink-receiving layer of the obtained recording sheet was 30 seconds. Therefore, this recording sheet was subjected to super calender treatment (line speed: 5 m/min, roll temperature: 20° C., nipping pressure: 50 kN/m) by a mini-super calender, to carry out smoothing treatment of the surface of the ink-receiving layer. The Oken smoothness of the surface of the ink-receiving layer after such treatment was 80 seconds.

### Evaluation

With respect to ink jet recording sheets of the above Examples 1 to 7, the Oken smoothness and the Stöckigt sizing degree of the paper substrate, the Oken smoothness of the ink-receiving layer surface, and further the developed color density, the ink-fixing property and the ink absorptivity, when ink jet printing was applied to each ink jet recording sheet by means of a pigment ink, were evaluated by the following methods. The results of these evaluations are shown in Table 1.

### Oken Smoothness

Measured in accordance with JAPAN TAPPI pulp and paper test method No. 5B.

### Stöckigt sizing degree

Measured in accordance with JIS P8122.

### Developed color density

Using an ink jet printer for pigment ink (FJ50, tradename, manufactured by Roland DG Corporation), gradation solid printing of black, cyan, yellow and magenta was carried out. The respective saturated reflection color densities were measured.

### Ink-fixing Property

Using an ink jet printer for pigment ink (FJ50, tradename, manufactured by Roland DG Corporation), gradation solid printing of black, cyan, yellow and magenta was carried out. As a peel test of ink, the printed portion was rubbed with a nail, and visual observation was carried out under the following standards.

◯: No substantial peeling of ink was observed.

Δ: Slight peeling of ink was observed.

X: Substantial peeling of ink was observed.

The evaluation results are shown in Table 1.

### Ink Absorptivity

Using an ink jet printer for pigment ink (FJ50, tradename, manufactured by Roland DG Corporation), gradation solid printing of black, cyan, yellow and magenta was carried out. The ink coalescence due to poor ink absorptivity at the solid printed portion was visually evaluated by the following standards.

◯: No ink coalescence was observed.

Δ: Slight ink coalescence was observed, but practically not problematic.

X: The ink coalescence remarkable, and practically useless.

TABLE 1

| | | Stöckigt | Oken | | | |
|---|---|---|---|---|---|---|
| | Oken | sizing | smoothness | | | |
| | smoothness | degree of | of ink- | | | |
| | of paper | paper | receiving | Developed color | | |
| | substrate | substrate | layer | densities | Ink-fixing | Ink- |
| Example | (Seconds) | (Seconds) | (Seconds) | Y/M/C/K | property | absorptivity |
| 1 | 100 | 210 | 300 | 1.16/1.46/1.88/2.04 | ◯ | ◯ |
| 2 | 100 | 210 | 1,000 | 1.26/1.54/1.93/2.15 | ◯ | Δ |
| 3 | 100 | 210 | 340 | 1.12/1.40/1.81/2.00 | Δ | ◯ |
| 4 | 35 | 35 | 60 | 1.13/1.44/1.85/2.01 | ◯ | ◯ |
| 5 | 100 | 210 | 35 | 1.01/1.21/1.58/1.72 | ◯ | ◯ |
| 6 | 5,000 or | Unmeasurable | 5,000 or | 1.13/1.44/1.90/2.05 | X | Δ |
| | more | | more | | | |
| 7 | 25 | 20 | 80 | 1.14/1.42/1.86/2.01 | ◯ | X |

In Table 1, the ink jet recording sheets of the present invention are excellent in the color-forming property, the ink absorptivity and the ink-fixing property for pigment ink.

As described in the foregoing, the present invention provides an ink jet recording sheet for pigment ink, which provides a high developed color density and an adequate property for fixing the pigment ink in the ink-receiving layer, while maintaining the merits of employing the pigment ink, such as light resistance, water resistance and little feathering, without necessity to provide a special pigment-fixing layer, and a recording method employing such an ink jet recording sheet for pigment ink.

The entire disclosure of Japanese Patent Application No. 2000-186395 filed on Jun. 21, 2000 including specification, claims and summary are incorporated herein by reference in its entirety.

1. An ink jet recording sheet for pigment ink, which comprises a paper substrate having a surface with an Oken smoothness of from 30 to 500 seconds and a Stöckigt sizing degree of from 30 to 2,000 seconds, and an ink-receiving layer comprising a pigment and a binder, formed on the surface of the substrate, wherein the Oken smoothness of the surface of the ink-receiving layer is from 50 to 2,000 seconds.

2. The ink jet recording sheet for pigment ink according to claim 1, wherein the ink-receiving layer contains alumina hydrate as the pigment and has a thickness of from 5 to 100 μm.

3. An ink jet recording method employing a pigment ink, which comprises applying a pigment ink by ink jet recording to an ink jet recording sheet for pigment ink, which comprises a paper substrate having a surface with an Oken smoothness of from 30 to 500 seconds and a Stöckigt sizing degree of from 30 to 2,000 seconds, and an ink-receiving layer comprising a pigment and a binder, formed on the surface of the substrate, wherein the Oken smoothness of the surface of the ink-receiving layer is from 50 to 2,000 seconds.
